(19) United States
(12) Patent Application Publication
(10) Pub. No.: US 2004/0011819 A1
(43) Pub. Date: Jan. 22, 2004

(54) Delivery device

(76) Inventors: Douglas Jennings, Nr Royston (GB); Bruce Macmichael, Nr Royston (GB); Michael Paton, Nr Royston (GB)

Correspondence Address: FISH & RICHARDSON PC, 225 FRANKLIN ST, BOSTON, MA, 02110, US

(21) Appl. No.: 10/381,762

(22) PCT Filed: Oct. 9, 2001
(86) PCT No.: PCT/SE01/02203

(30) Foreign Application Priority Data
Oct. 11, 2000 (SE) 003666-5

(51) Int. Cl. B67D 5/64

(52) U.S. Cl. 222/162

(57) ABSTRACT

The present invention relates to a manually actuatable delivery device for the delivery of a volume of liquid, comprising a housing (1a, 1b, 1c) which includes an outlet (2) through which liquid, in use, is delivered, a liquid delivery unit (5) which is located within the housing (1a, 1b, 1c) and a actuating means (1c) moveable from a first position to a second position when acted upon by a user. The liquid delivery unit (5) is held by a locking mechanism (17, 18) in a non-actuatable mode and the actuating means (1c) cooperates with an interfering member (7) as it moves from the first position to the second position such that the interfering member (7) eventually releases the liquid delivery unit (5) from the locking mechanism (17, 18) to enable delivery of the liquid.

The present invention relates to a manually actuated delivery device for the delivery of a volume of liquid, in particular, a liquid containing medicament.

WO-92/20455 discloses one example of such a delivery device which takes the form or a nasal inhaler for the delivery of a volume of liquid containing medicament as a spray into a nasal cavity. This delivery device includes a nosepiece in the form of an elongate tubular section for insertion into a nasal cavity. The distal end nosepiece delivers the spray and is configured to be manually actuated by the application of a force axially relative to the longitudinal axis of the nosepiece.

Whilst such a delivery device is capable of delivering a volume of liquid, in practice, use as a nasal spray can prove troublesome since the actual volume of liquid delivered and the energy of delivery can be dependent on the force applied by the user. Moreover, the axial application of force tends to cause axial movement of the nosepiece within the nasal cavity which can lead to inefficient delivery of liquid.

The present invention, therefore, aims to overcome the aforementioned problems by ensuring that the volume and energy of liquid delivered is consistent and by providing a delivery device which is configured such that the force applied by the user is substantially orthogonal to the axis of delivery of liquid. With such a configuration, inadvertent withdrawal or movement of the nosepiece can be avoided.

The main advantage of the present invention is the locking of the liquid delivery unit into a non-actuatable mode after each delivery of liquid to avoid unintentional actuation unless force is applied by the user in the required manner.

An additional advantage of the present invention arises by virtue of the use of a biasing means to actuate delivery of liquid which results in a consistent energy of delivery regardless of the force applied by the user.

According to the present invention, there is provided a manually actuatable delivery device for the delivery of a volume of liquid comprising:

a housing which includes an outlet through which liquid, in use, is delivered;

a liquid delivery unit which is located within the housing; and

an actuating means moveable from a first position to a second position when acted upon by a user characterised in that

the liquid delivery unit is held by a locking mechanism in a non-actuatable mode and the actuating means cooperates with an interfering member as it moves from the first position to the second position such that the interfering member eventually releases the liquid delivery unit from the locking mechanism to enable delivery of the liquid.

Preferably, the interfering member is moveable against the biasing action of a biasing means.

Preferably, the actuating means lifts the interfering member into contact with the locking mechanism.

Preferably, the locking mechanism is formed partly by the housing and partly by a carrier unit for the liquid delivery unit.

Preferably, the liquid delivery unit and the carrier unit are slidable as a single unit within the housing.

Preferably, the interfering member is an inner sleeve which is slidable within the housing as the actuating means moves from the first position to the second position.

Preferably, the inner sleeve comprises a projection which cooperates with the locking mechanism to allow release of the liquid delivery unit.

Preferably, the locking mechanism comprises a plurality of resilient fingers extending from the base of the housing which grip a part of the carrier unit until the projection on the inner sleeve moves to release their grip on the carrier unit.

Preferably, the biasing means is located between the inner sleeve and the carrier unit, the inner sleeve moving against the biasing action of the biasing means such that on release of the carrier unit from the resilient fingers the liquid delivery unit is forced by the biasing means to deliver a volume of liquid.

Preferably, the liquid delivery unit comprises a container for the liquid and a pump with a tubular nozzle, the tubular nozzle being slidable into the container to deliver a volume of liquid as a result of cooperation with a tubular feed within the housing when the liquid delivery unit is released from the locking mechanism.

Preferably, the user actuates the actuating means by applying a force substantially orthogonal to the axis of delivery of the liquid.

A preferred embodiment of the present invention will now be described in detail, by way of example only, with reference to the accompanying drawings, of which:

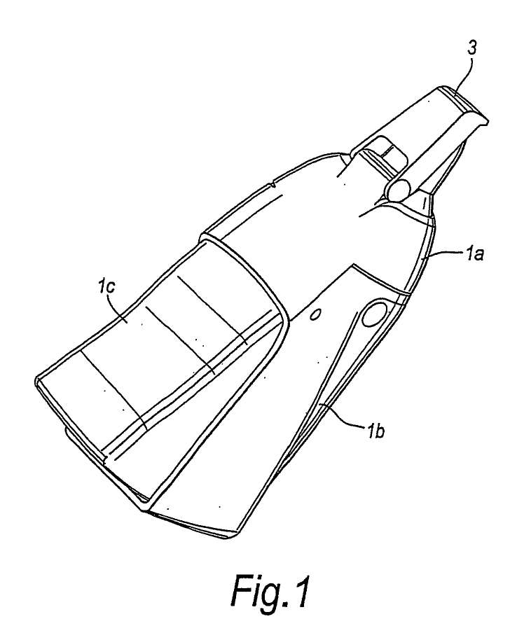

FIG. 1 is a perspective view of the delivery device;

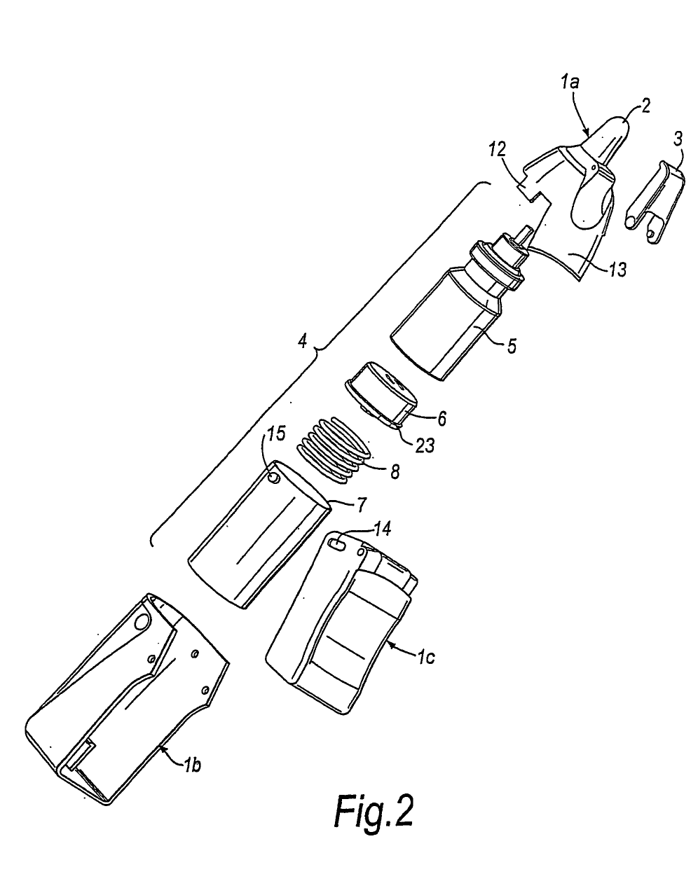

FIG. 2 is an exploded view in perspective of all the features of the delivery device;

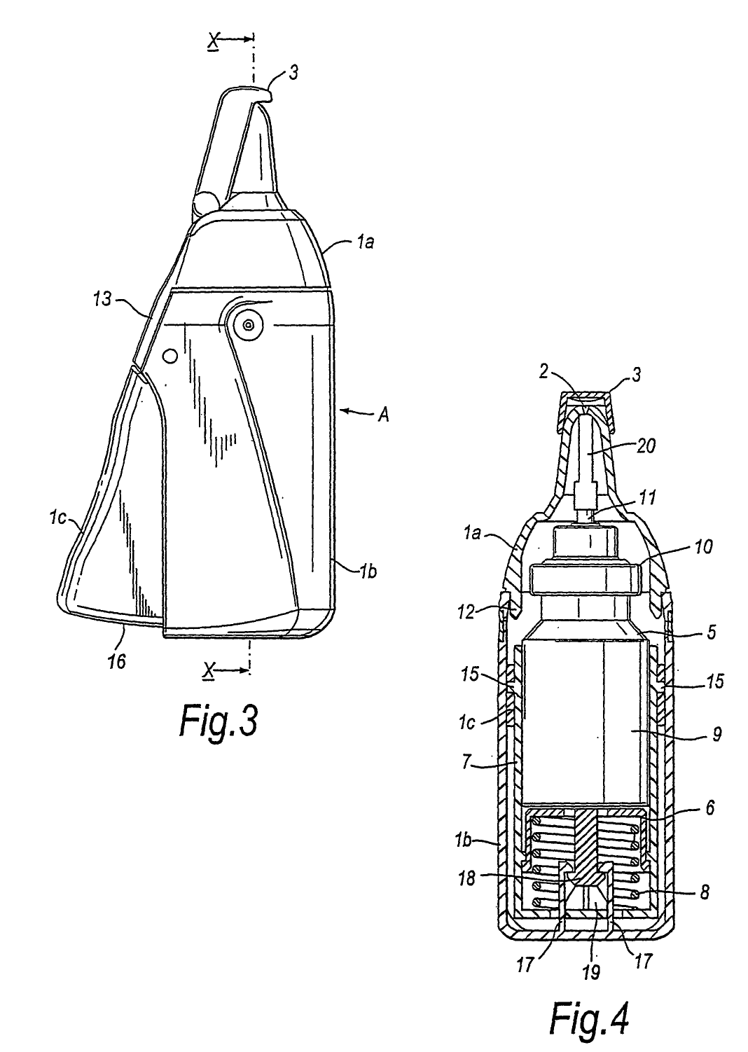

FIG. 3 is a view from the right hand side of the delivery device in FIG. 1;

FIG. 4 is a sectional view in direction X-X of the delivery device in FIG. 3;

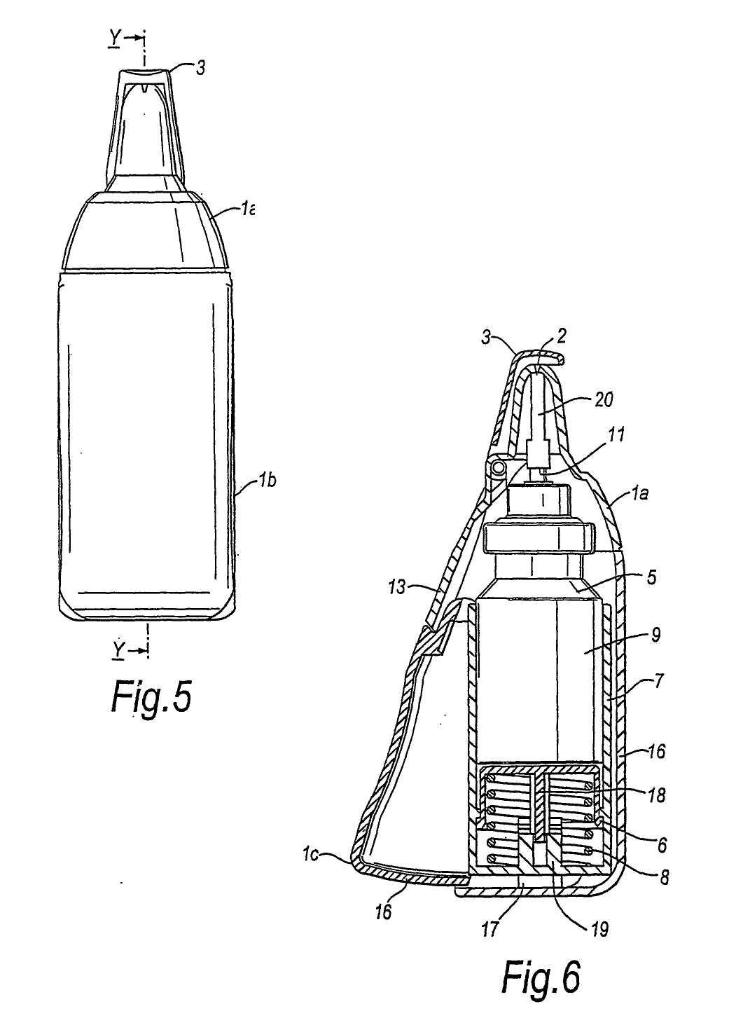

FIG. 5 is a view in direction A of the delivery device in FIG. 3;

FIG. 6 is a sectional view in direction Y-Y of the delivery device in FIG. 5;

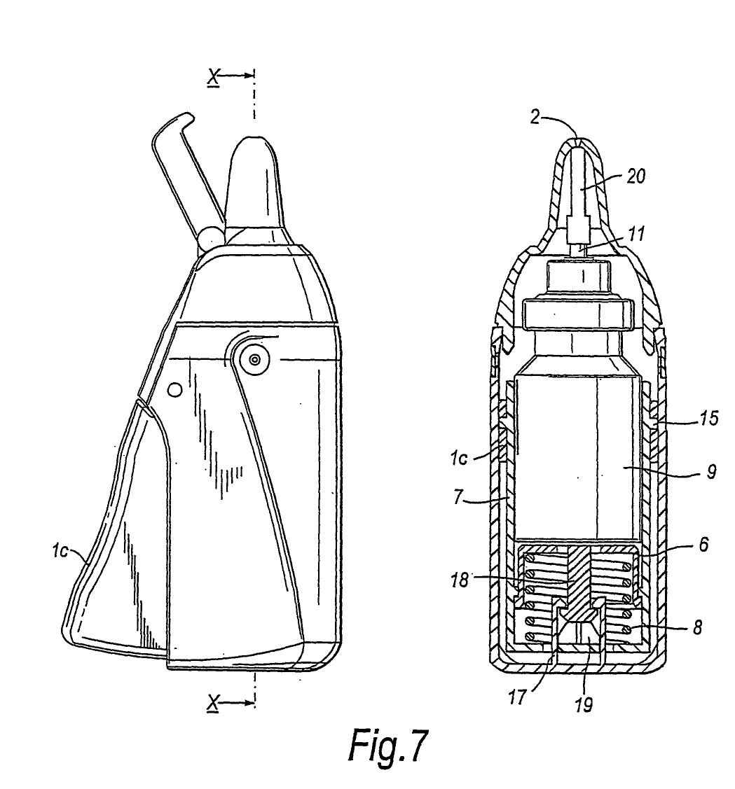

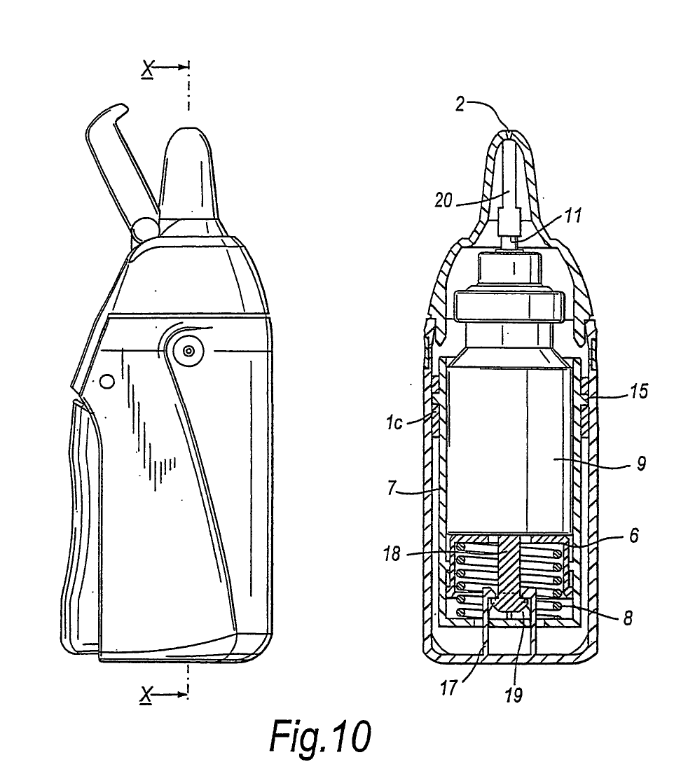

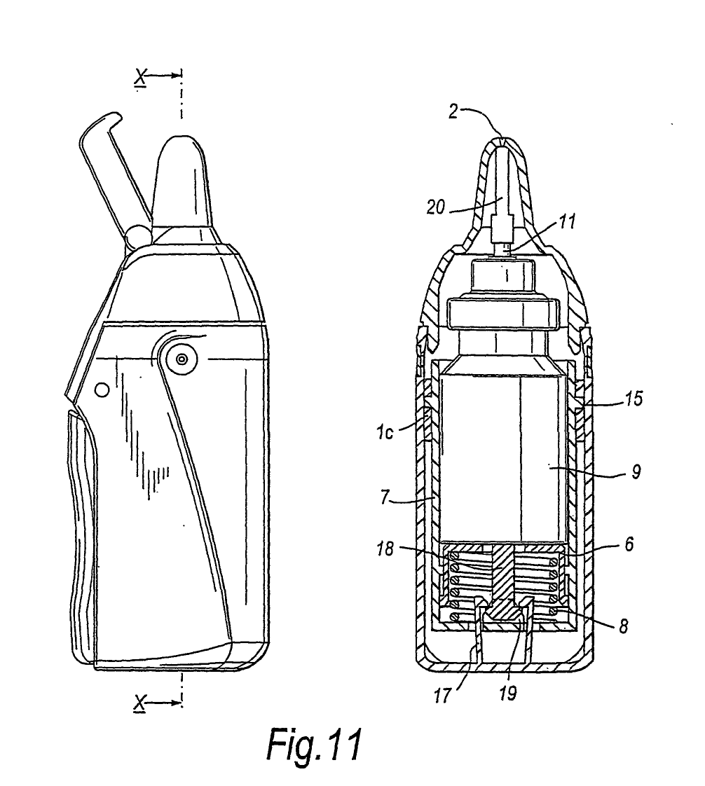

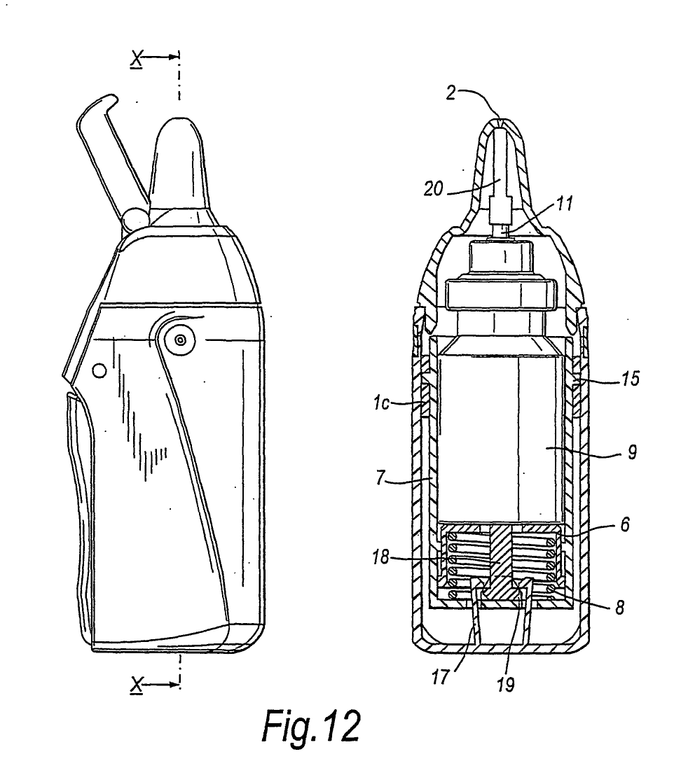

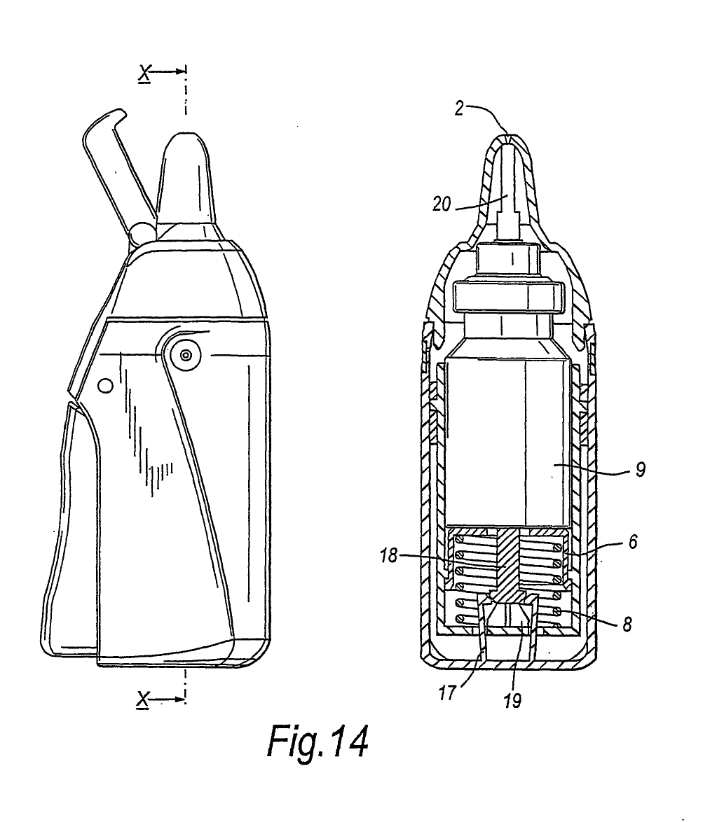

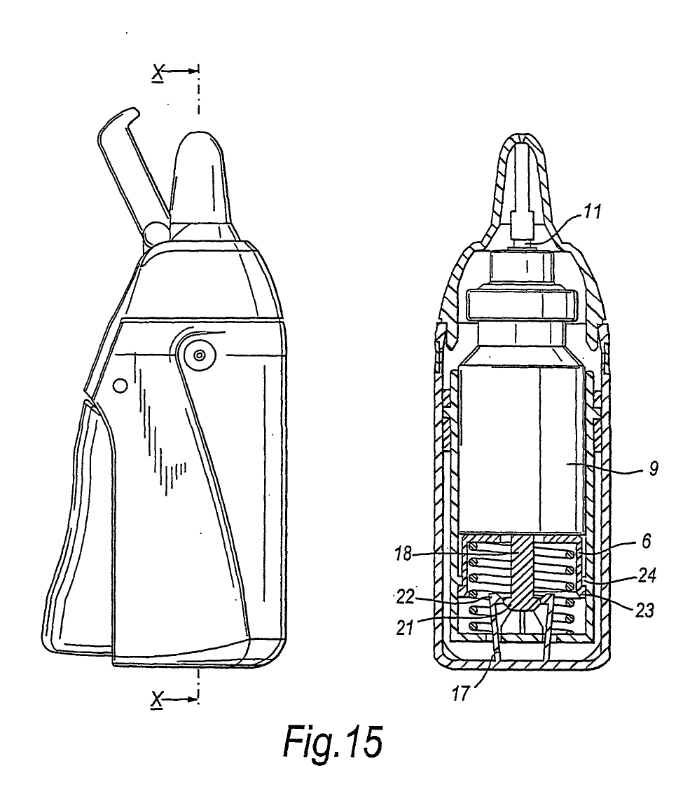

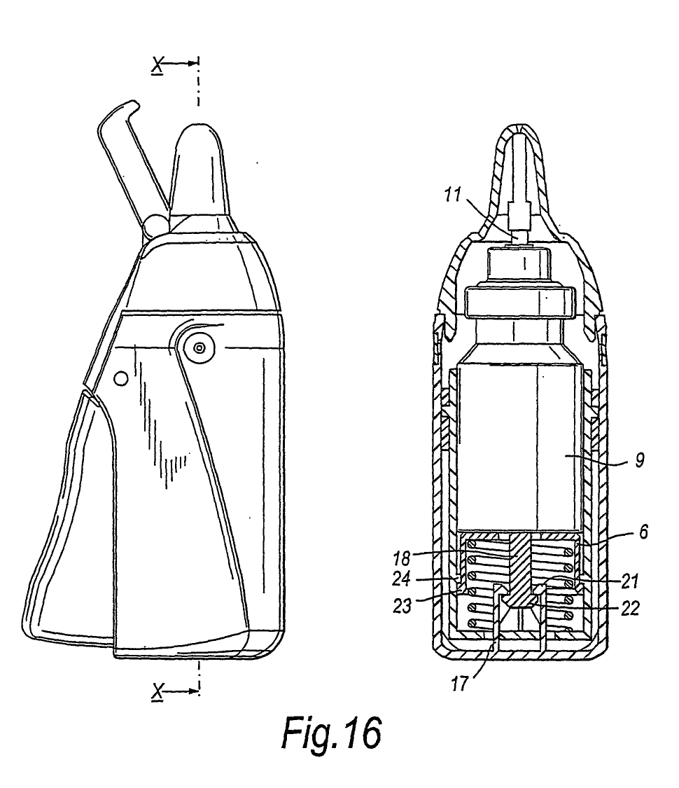

FIGS. 7 to 17 correspond to the views in FIGS. 3 and 4 and depict the delivery device at various stages of actuation of the liquid delivery.

The delivery device in FIG. 1 comprises a housing 1 having an upper body portion 1a, a lower body portion 1b and an actuating body portion 1c. The upper body portion 1a includes an outlet 2 through which liquid is delivered. Preferably, the outlet 2 is provided with a cover member 3 which, in this embodiment, is hinged to the upper body portion 1a and pivots between a first position which covers the outlet 2 and a second position which reveals the outlet 2 when the user wishes to actuate the delivery device. The housing 1 is typically formed of a plastics material and the portions 1a and 1b can be joined by a plastics weld.

In FIG. 2, the exploded view depicts the internal elements within the housing 1 which form the liquid delivery assembly 4. The liquid delivery assembly 4 includes a liquid delivery unit 5, a carrier unit 6 which carries the liquid delivery unit 5, an interfering member 7 and a spring 8.

Reference should now be made to FIG. 4 which depicts the delivery device in cross-section. The liquid delivery unit 5 is a typical liquid delivery pump comprising a container 9 for liquid and a pump 10 with a tubular nozzle 11. The tubular nozzle 11 is slidable against the action of an internal return spring (not shown) into the container 9 to deliver a volume of liquid.

The upper body portion 1a is connected to the lower body portion 1b by a plurality of resilient tabs 12 which form a snap-fit to secure the housing portions together. A plastics weld can also be used which can be achieved, for example, by ultrasonic welding.

FIG. 3 is a side view of the delivery device in FIG. 1, from which it can be seen that the upper body portion 1a comprises a skirt portion 13 which is contoured to align with the actuating body portion 1c.

The actuating body portion 1c has a slot 14 on each slide which cooperates with a respective projection 15 on each side of the interfering member 7 which is in the form of an inner sleeve. The actuating body portion 1c can pivot on the projections 15 and in doing so lifts the inner sleeve 7 as it is pressed inwardly to actuate liquid delivery.

The actuating body portion 1c has a base 16 which is slidable between the base of lower body portion 1b and the base of the inner sleeve 7.

The liquid delivery unit 5 sits on and is carried by the carrier unit 6. A spring 8 is located between the carrier unit 6 and the base of the inner sleeve 7. The spring 8 biases the inner sleeve 7 towards the base of lower body portion 1b until the actuating body portion 1c is pressed by a user. In the non-actuating mode (FIG. 4), the carrier unit 6 is held by the lower body portion 1b. Therefore, the liquid delivery unit 5 cannot move upwardly and the tubular nozzle 11 will not slide into the container 9 to deliver a volume of liquid.

The lower body portion 1b includes a plurality of resilient fingers 17 which hold an elongate element 18 extending downwardly from the carrier unit 6. The inner sleeve 7 has a projection 19 which can slide past the elongate element 18 to urge the fingers 17 to separate and release the elongate element 18 when the inner sleeve 7 is forced to slide upwardly by pressing actuating body portion 1c. In FIG. 4, the spring 8 is extended and the inner sleeve 7 sits at its lowest position within the housing 1.

The operation of the delivery device will now be explained with reference to FIGS. 7 to 17 which depict various stages of actuation.

In FIG. 7, the actuating body portion 1c has not been pressed by a user. Therefore, spring 8 is extended and biases the inner sleeve 7 into its lowest position within the housing 1.

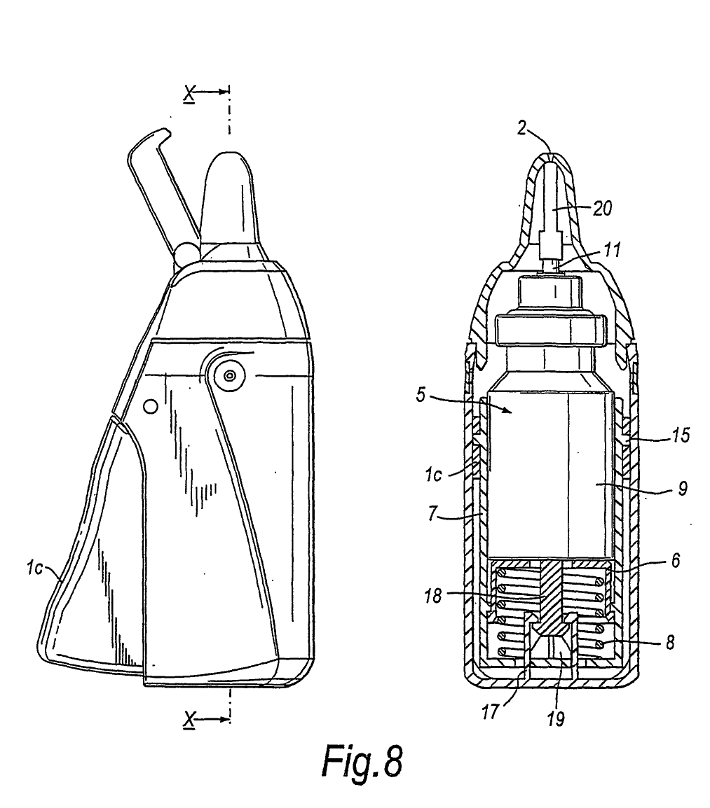

In FIG. 8, the user has started to actuate the delivery device which results in the base 16 of the actuating body portion 1c sliding beneath the inner sleeve 7 to push the inner sleeve upwardly. The liquid delivery unit 5 remains in position with the carrier unit 6 and therefore, the spring 8 begins to compress as the upward stroke commences.

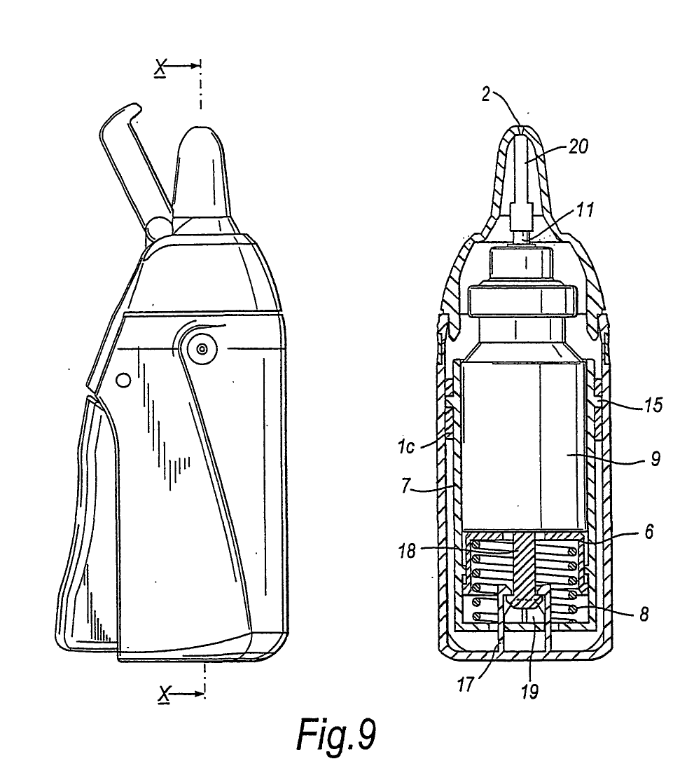

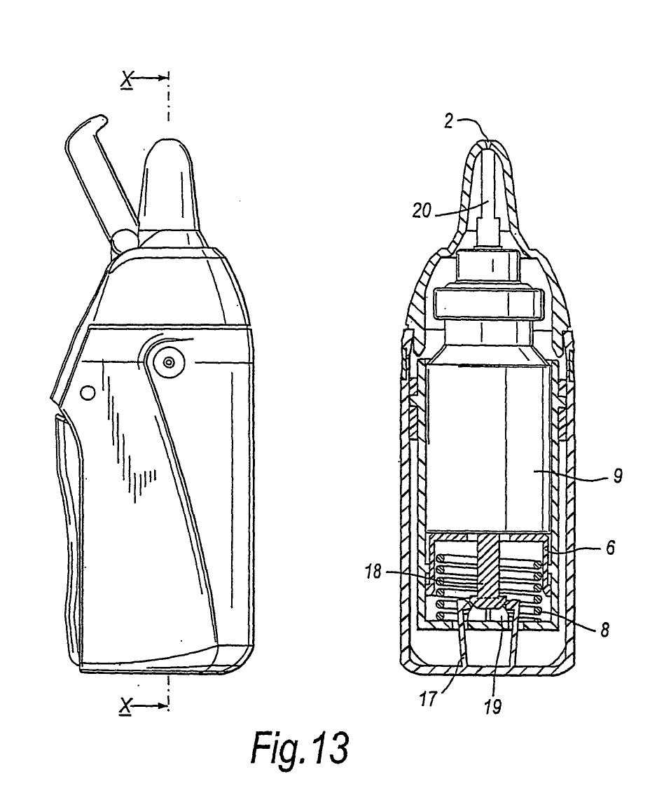

FIGS. 9 to 12 depict how the projection 19 on the inner sleeve 7 slides upwardly to eventually make contact with the fingers 17 forcing them apart to release the elongate element 18 on the carrier unit. During this stage of actuation, the spring 8 is progressively compressed until the elongate element 18 is released (FIG. 13). At this point, the stored energy in the spring 8 is also released and the carrier unit 6 with the liquid delivery unit 5 are pushed upwardly sliding within the inner sleeve 7. The tubular nozzle 11 then cooperates with a tubular feed 20 in the upper body portion 1a which pushes the tubular nozzle 11 into the container 9 thereby delivering a volume of liquid. After delivery, the user releases the actuating body portion 1c allowing the inner sleeve 7 to fall again to the lowest position. The carrier unit 6 is provided with a flange 23 which cooperates with a rim 24 on the internal surface of the inner sleeve 7 as it falls and is held there by spring 8 in its extended position. In this position, the inner sleeve 7, spring 8 and container 9 all move downwards, being pushed by the action of the internal return spring (not shown) located inside the pump 10. The internal return spring finally pushes the elongate element 18 between fingers 17.

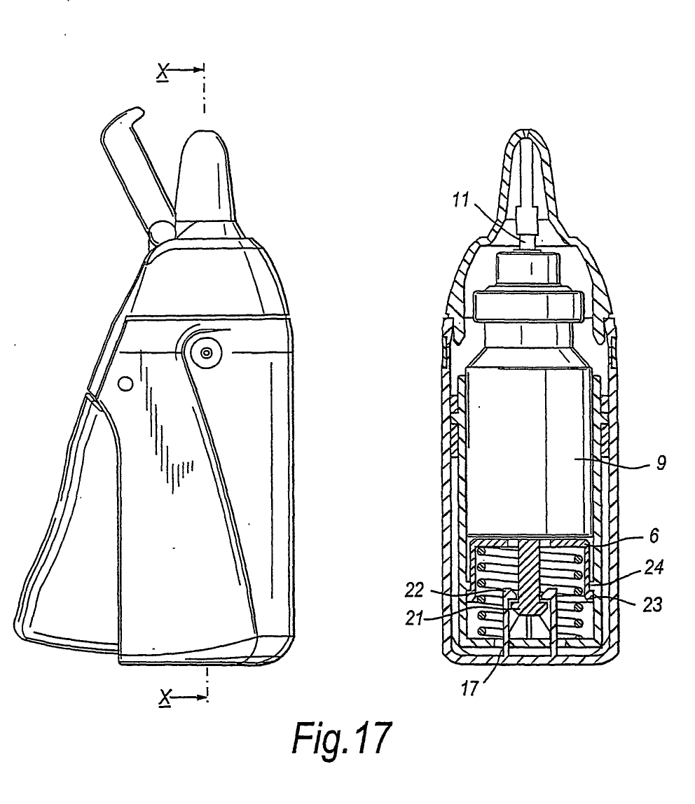

In FIG. 17, the actuation has been completed and the liquid delivery assembly sits again in the non-actuatable mode until the user wishes to deliver a further volume of liquid. In this way, the delivery device is able to deliver a substantially constant volume of liquid with a consistent energy of delivery regardless of the force applied by the user to the actuating means.

Whilst the delivery device described is actuated by applying a force substantially orthogonal to the axis of the delivered liquid, it will be understood that alternative actuating means could be employed with the locking mechanism according to the present invention.

1. A manually actuatable delivery device for the delivery of a volume of liquid comprising:
a housing which includes an outlet through which liquid, in use, is delivered;
a liquid delivery unit which is located within the housing; and
an actuating means moveable from a first position to a second position when acted upon by a user characterised in that
the liquid delivery unit is held by a locking mechanism in a non-actuatable mode and the actuating means cooperates with an interfering member as it moves from the first position to the second position such that the interfering member eventually releases the liquid delivery unit from the locking mechanism to enable delivery of the liquid.

2. A manually actuatable delivery device as claimed in claim 1, wherein the interfering member is moveable against the action of a biasing means.

3. A manually actuatable delivery device as claimed in claim 2, wherein the actuating means lifts the interfering member into contact with the locking mechanism.

4. A manually actuatable delivery device as claimed in claim 3, wherein the locking mechanism is formed partly by the housing and partly by a carrier unit for the liquid delivery unit.

5. A manually actuatable delivery device as claimed in claim 4, wherein the liquid delivery unit and the carrier unit are slidable as a single unit within the housing.

6. A manually actuatable delivery device as claimed in claim 5, wherein the interfering member is an inner sleeve which is slidable within the housing as the actuating means moves from the first position to the second position.

7. A manually actuatable delivery device as claimed in claim 6, wherein the inner sleeve comprises a projection which cooperates with the locking mechanism to allow release of the liquid delivery unit.

8. A manually actuatable delivery device as claimed in claim 7, wherein the locking mechanism comprises a plurality of resilient fingers extending from the base of the housing which grip a part of the carrier unit until the projection on the inner sleeve moves to release their grip on the carrier unit.

9. A manually actuatable delivery device as claimed in claim 8, wherein the biasing means is located between the inner sleeve and the carrier unit, the inner sleeve moving against the biasing action of the biasing means such that on release of the carrier unit from the resilient fingers the liquid delivery unit is forced by the biasing means to deliver a volume of liquid.

10. A manually actuated delivery device as claimed in any of claims 4 to 7, wherein the liquid delivery unit comprises a container for the liquid and a pump with a tubular nozzle, the tubular nozzle being slidable into the container to deliver a volume of liquid as a result of cooperation with a tubular feed within the housing when the liquid delivery unit is released from the locking mechanism.

11. A manually actuated delivery device as claimed in any preceding claim, wherein the user actuates the actuating means by applying a force substantially orthogonal to the axis of delivery of the liquid.

12. A manually actuated delivery device substantially as herein described with reference to the accompanying drawings.
